(19) United States
(12) Patent Application Publication
(10) Pub. No.: US 2025/0198559 A1
(43) Pub. Date: Jun. 19, 2025

(54) HOSE WITH INDICATOR

(71) Applicant: BRIDGESTONE CORPORATION, Tokyo (JP)

(72) Inventors: Taisuke KURODA, Tokyo (JP); Koji SUZUKI, Tokyo (JP); Ryo KAGAMI, Tokyo (JP); Takayuki SUGIMURA, Tokyo (JP)

(73) Assignee: BRIDGESTONE CORPORATION, Tokyo (JP)

(21) Appl. No.: 18/954,801

(22) Filed: Nov. 21, 2024

(30) Foreign Application Priority Data
Dec. 13, 2023 (JP) 2023-210593

(51) Int. Cl. F16L 57/06; F16L 11/04

(52) U.S. Cl. CPC F16L 57/06; F16L 11/04; F16L 2201/60

(57) ABSTRACT

The provided is a hose with an indicator (30), comprising: a hose body (30a) made of rubber that forms a fluid flow path therein; a fitting (30b) made of metal connected to an end of the hose body; and an indicator (31) in which color components are extracted by a deterioration state determination device provided with a deterioration determination model and a color change database in order to determine deterioration state of the hose body, wherein the indicator has a plurality of color patterns (33) composed of colors that are sensitive to deterioration factors, and is attached to an external surface of the hose body so that the color patterns can be seen from each of at least two different directions when the hose is viewed from those directions.

### TECHNICAL FIELD

This disclosure is related to a hose with an indicator.

### BACKGROUND

A hose is a flexible tube used for transporting fluids and transmitting pressure, and is used for a variety of purposes. Rubber hoses, which are mainly made of rubber, are widely used (see FIG. 13). The deterioration of the rubber part is sometimes difficult to see from the outside, and it is especially difficult to grasp the deterioration of the inner rubber, which is close to the fluid flow path. For example, Patent Document 1 discloses a method for determining the degree of deterioration of the inner rubber by: dividing the temperature data detected by the temperature sensor into a plurality of temperature ranges; and with the representative temperature in each temperature range as the temperature condition, calculating the heat aging life of the inner rubber based on each representative temperature and the correlation.

### CITATION LIST

### Patent Literature

PTL 1: JP 2020-186983 A
PTL 2: JP2023-097221 A

### SUMMARY

However, the method described in Patent Document 1 requires a temperature sensor to be installed in the hose to detect the temperature of the fluid sequentially. Since hoses are also used outdoors, a high-precision, high-durability temperature sensor that can accurately measure temperature even in outdoor environments is required. However, it is difficult to attach such a temperature sensor to a hose, especially from a cost perspective. Here, Patent Document 2 discloses an indicator that makes it possible to determine the deterioration state of an object with high accuracy. However, the indicator must be attached in a place where it is easily visible. For example, if the object is a tire, it can be attached to the bottom of the tread grooves to ensure visibility. However, in the case of a hose, the visibility of different parts depends on how it is used. For example, if the hose is placed with one side facing a wall, it may not be possible to determine the state of deterioration if an indicator is attached to that side.

In light of the above circumstances, the purpose of this disclosure is to provide a hose with an indicator that can determine the state of deterioration regardless of the usage state of the hose.
(1) The hose with an indicator according to one embodiment of the present disclosure comprises:
a hose body made of rubber that forms a fluid flow path therein;
a fitting made of metal connected to an end of the hose body; and
an indicator in which color components are extracted by a deterioration state determination device provided with a deterioration determination model and a color change database in order to determine deterioration state of the hose body, wherein
the indicator has a plurality of color patterns composed of colors that are sensitive to deterioration factors, and is attached to an external surface of the hose body so that the color patterns can be seen from each of at least two different directions when the hose is viewed from those directions.
(2) As an embodiment of the present disclosure, in the above (1),
the indicator is attached in a spiral pattern to the external surface of the hose body.
(3) As an embodiment of the present disclosure, in the above (1),
the indicator is attached in a circumferential direction at a plurality of positions on the hose body.
(4) As an embodiment of the present disclosure, in any one of above (1) to (3),
in the color patterns, a plurality of colors with different sensitivities to the deterioration factors are applied to different positions.
(5) As an embodiment of the present disclosure, in any one of above (1) to (4),
the color pattern is configured to include a plurality of color components that show different changes in response to one of the deterioration factors.
(6) As an embodiment of the present disclosure, in any one of above (1) to (5),
the deterioration factors include at least one of heat, oxygen, water, ultraviolet rays, and ozone.

According to this disclosure, it is possible to provide a hose with an indicator that can determine the state of deterioration regardless of the usage state of the hose.

### BRIEF DESCRIPTION OF THE DRAWINGS

In the accompanying drawings:

FIG. 1 illustrates an exemplary configuration of a deterioration state determination device;

FIG. 2 illustrates an exemplary configuration of a deterioration state determination system comprising the deterioration state determination device illustrated in FIG. 1;

FIG. 3 illustrates an exemplary configuration of an indicator;

FIG. 4 is a flowchart providing an example of the first process included in a method for determining the deterioration state executed by the deterioration state determination device illustrated in FIG. 1;

FIG. 5 illustrates an exemplary configuration of a color change database;

FIG. 6 is a flowchart providing an example of the second process included in a method for determining the deterioration state executed by the deterioration state determination device illustrated in FIG. 1;

FIG. 7 illustrates an exemplary configuration of an indicator database;

FIG. 8 is a flowchart providing an example of the third process included in a method for determining the deterioration state executed by the deterioration state determination device illustrated in FIG. 1;

FIG. 9 illustrates an exemplary configuration of a hose with an indicator in accordance with one embodiment of the present disclosure;

FIG. 10 explains arrangement of color patterns in the indicator;

FIG. 11 illustrates an exemplary cross-section of a hose body 30;

FIG. 12 illustrates another exemplary configuration of a hose with an indicator in accordance with one embodiment of the present disclosure; and

FIG. 13 is a perspective view illustrating the layered structure of the hose body.

### DETAILED DESCRIPTION

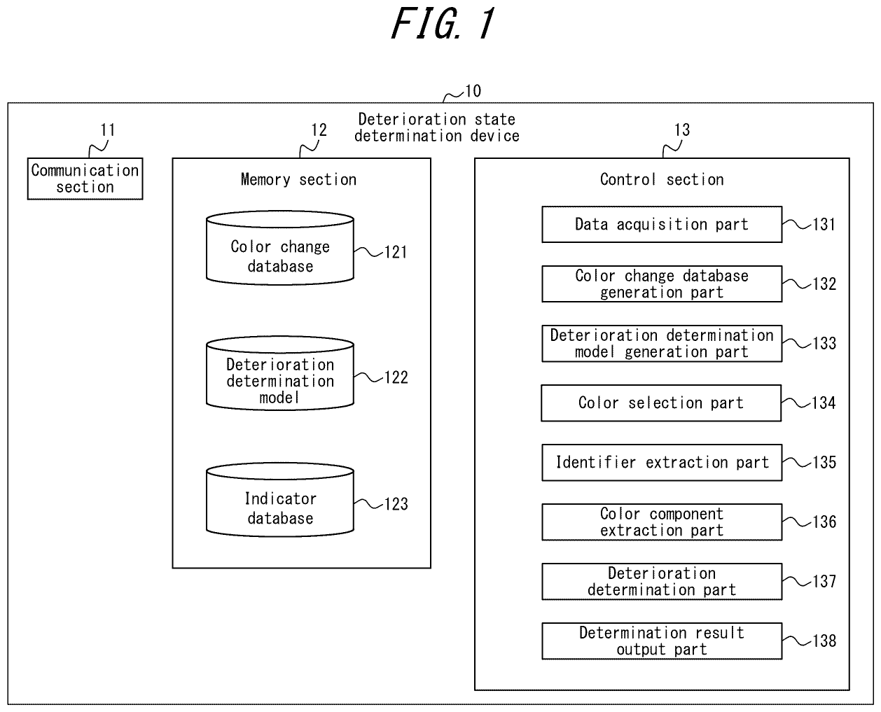

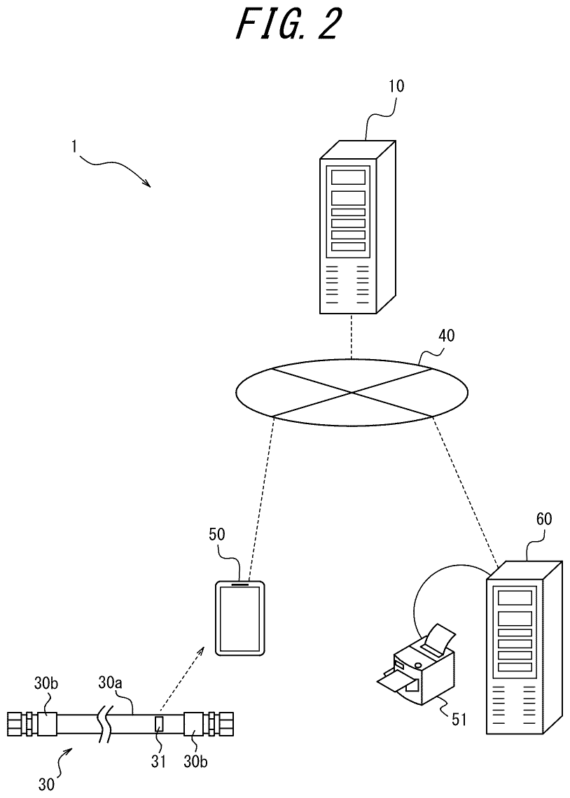

The following is an explanation of a hose 30 with an indicator 31 (see FIG. 2) in accordance with one embodiment of the present disclosure, with reference to the drawings. In each figure, the same or equivalent parts are marked with the same symbol. In the explanation of this embodiment, the same or equivalent parts are omitted or simplified as appropriate. The indicator 31 is used to determine the deterioration state of the hose 30, which is the object to which the indicator 31 is attached, using a deterioration state determination device 10 (see FIG. 1). First, the deterioration state determination device 10 will be explained.

FIG. 1 illustrates an exemplary configuration of the deterioration state determination device 10. FIG. 2 illustrates an exemplary configuration of a deterioration state determination system 1 comprising the deterioration state determination device 10 illustrated in FIG. 1. The deterioration state determination device 10 is a device that determines the deterioration state of an object based on the color of the indicator 31 attached to the object to be determined. In this embodiment, the object is a hose 30. The hose 30 is a rubber hose. The deterioration state of the hose 30 as determined by the deterioration state determination device 10 may be used, for example, to present the user with information such as the expected service life and messages to encourage replacement. The deterioration of the hose 30 includes cases that are difficult to see from the outside (such as hardening), but can be determined with high accuracy using the deterioration state determination device 10. In this case, the user is the hose 30 user.

The deterioration state determination device 10 comprises a communication section 11, a memory section 12, and a control section 13. The control section 13 comprises a data acquisition part 131, a color change database generation part 132, a deterioration determination model generation part 133, a color selection part 134, an identifier extraction part 135, a color component extraction part 136, a deterioration determination part 137, a determination result output part 138. The deterioration state determination device 10 may be a computer, such as a server computer, for example, as a hardware configuration. The details of the components of the deterioration state determination device 10 will be described later.

The deterioration state determination device 10 may constitute a deterioration state determination system 1 together with at least one of a terminal device 50, a printing device 51, and a server 60 connected by a network 40. The network 40 is, for example, the Internet. The network 40 may also be configured to include a local area network (LAN), for example, in part thereof.

The terminal device 50 is a general-purpose mobile terminal, such as a smartphone or a tablet, but it is not limited to such mobile terminals as long as the device is provided with a camera function and a display function. The terminal device 50 is used by the user when the deterioration state of the hose is to be determined, etc. The terminal device 50 may capture an image of the indicator 31 attached to the hose 30 using its imaging function and transmit the captured image to deterioration state determination device 10 via the network 40. The imaging function is realized by the camera provided to, for example, the terminal device 5. In addition, the terminal device 50 may acquire the deterioration state determination results from the deterioration state determination device 10 via the network 40 and display them to the user using a display function. The display function is realized by a display such as the LCD (Liquid Crystal Display) provided in the terminal device 50. Here, the terminal device 50 may be provided with a touch panel display integrated with a touch sensor that detects contact by the user and identifies the position of the contact.

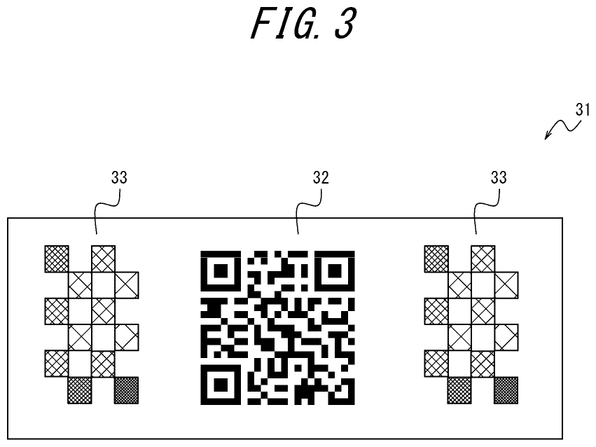

The printing device 51 is, for example, a color inkjet printer, but it is not limited to color inkjet printers if it is a device capable of printing a plurality of color components. The printing device 51 is used to print an identifier 32 and a color pattern 33 (see FIG. 3), which are explained below, on a printing medium such as paper, film (film-like resin) or rubber when creating the indicator 31 attached to the hose 30. In this embodiment, the printing device 51 acquires printing data from the deterioration state determination device 10 via the network 40 and the server 60, and then executes printing to create the indicator 31. Here, the printing data is indicator data that includes the data for the identifier 32 and the color pattern 33.

The server 60 is, for example, a different computer from the deterioration state determination device 10. The server 60, for example, is installed in a different location from the deterioration state determination device 10, and in addition to relaying the indicator data to the printing device 51, it may manage data such as the history of manufacture, sales, or replacement of the hose 30. The server 60 may be, for example, the computer at a store that sells the hose 30, or a computer at the manufacturing site where the hose 30 is manufactured.

Here, we will explain the outline of the method of determining the deterioration state executed by the deterioration state determination device 10. It is generally known that printed materials printed by color inkjet printers and other devices fade over time due to changes in the ink. Even in the same environment, the degree of fading varies depending on the color of the ink. In addition, even the same printed material will fade to different degrees depending on the environmental deterioration factors (e.g. heat, ultraviolet rays, etc.). In this embodiment, for example, when replacing the hose 30, the indicator 31 is attached to the new hose 30. After that, the deterioration state determination device 10 acquires an image of the indicator 31 and calculates the amount of deterioration factors in the environment where the hose 30 was used from the color change of the indicator 31. The deterioration state determination device 10 then determines the deterioration state of the hose 30 based on the calculated amount of the deterioration factors.

FIG. 3 illustrates the configuration of an indicator 31 according to this embodiment. The indicator 31 has an identifier 32 and a color pattern 33 printed on a printing medium. The indicator 31 can be created inexpensively by printing with the printing device 51. In this embodiment, the identifier 32 is a 2D code, but it is not limited to 2D codes as long as the indicator 31 can be individually identified. In addition, the color pattern 33 is composed of colors that are sensitive to the deterioration factors. In this embodiment, the color pattern 33 is composed of a plurality of colors applied to different positions. In addition, in this embodiment, the color pattern 33 is arranged in a checkerboard pattern, but the present disclosure is not limited to this arrangement. Based on the changes in the color pattern 33, the deterioration state determination device 10 determines the deterioration state of the hose 30. The selection of colors used in the color pattern 33 is described later.

Here, the deterioration state determination system 1 is not limited to the configuration illustrated in FIG. 2. In this embodiment, the printing device 51 is connected to the network 40 via the server 60, but for example, the printing device 51 may be directly connected to the network 40. In such cases, the deterioration state determination system 1 may be configured with the deterioration state determination device 10, the terminal device 50, and the printing device 51, omitting the server 60.

The following explains the details of the components of the deterioration state determination device 10. The communication section 11 is configured to include one or more communication modules that connect to the network 40. The communication section 11 may include a communication module that corresponds to mobile communication standards such as 4G (4th Generation) and 5G (5th Generation). The communication section 11 may include a communication module that corresponds to a wired or wireless LAN standard, for example.

The memory section 12 is one or more memories. The memories can be, for example, semiconductor memories, magnetic memories, or optical memories, but they are not limited to these and can be any memory. The memory section 12 is, for example, built into the deterioration state determination device 10, but it can also be configured to be accessed externally by the deterioration state determination device 10 via an arbitrary interface.

The memory section 12 stores various data used in the various calculations performed by the control section 13. In addition, the memory section 12 may store the results of various calculations and intermediate data executed by the control section 13.

In this embodiment, the memory section 12 includes a color change database 121, a deterioration determination model 122, and an indicator database 123. The color change database 121 is configured to include data that shows the relationship between color change of the indicator 31 and the amount of deterioration factors that deteriorate the hose 30. The deterioration determination model 122 is a model for determining the deterioration state of the hose 30 based on the amount of deterioration factors. The deterioration determination model 122 may be a mathematical model that, for example, takes the amount of deterioration factors as input and outputs the predicted service life, or it may be generated by machine learning or other means. The indicator database 123 is configured to include data that associates the identifier 32 of the indicator 31 with the information on the color pattern 33. The information on the color pattern 33 includes the colors used and the color components that make up each color. In addition, the information on the color pattern 33 may include the position of each color, the type of pattern used for the color arrangement (e.g. checkerboard pattern), etc. In addition, the information on the color pattern 33 may include the initial state of each color in terms of the gradation for each color component. The initial state here is the state when the indicator 31 is created.

The control section 13 is one or more processors. The processor can be any processor, not limited to general-purpose processors or dedicated processors specialized for specific processing. The control section 13 controls the overall operation of the deterioration state determination device 10.

Here, the deterioration state determination device 10 may have the following software configuration. One or more programs used to control the operation of the deterioration state determination device 10 are stored in the memory section 12. The program stored in the memory section 12 is read by the processor in the control section 13, and the control section 13 is made to function as each functional part. In other words, the control section 13 functions as the data acquisition part 131, the color change database generation part 132, the deterioration determination model generation part 133, the color selection part 134, the identifier extraction part 135, the color component extraction part 136, the deterioration determination part 137 and the determination result output part 138, by the program.

The data acquisition part 131 acquires the experimental data and images of the indicator 31 described below via the network 40 and the communication section 11.

The color change database generation part 132 generates the color change database 121 and stores the generated color change database 121 in the memory section 12. The color change database generation part 132 can generate the color change database 121 by extracting color information and deterioration factor information from the experimental data, and generating data that shows the relationship between color change and the amount of deterioration factors.

The deterioration determination model generation part 133 generates the deterioration determination model 122 and stores the generated deterioration determination model 122 in the memory section 12. The deterioration determination model 122 is a model that takes the amount of deterioration factors as input and outputs an index of the deterioration state of the hose 30. The index of the deterioration state of the hose 30 is an index related to durability, such as service life, but is not limited to this. The deterioration determination model generation part 133 may acquire actual data indicating the actual deterioration state of the hose 30 that can be acquired via the network 40 and the communication section 11, and generate the deterioration determination model 122 based on the actual data. The actual data may be data obtained from experiments showing the state of deterioration when a specific amount of a specific deterioration factor is applied to the hose 30, for example. As a concrete example, the actual data may indicate the actual service life of a specific type of new hose 30 when it is left in an environment with a temperature of 20 to 80° C. and an oxygen content of 20 to 80% for 10 to 10000 hours. The deterioration determination model generation part 133 may generate the deterioration determination model 122 by machine learning using the actual data as training data.

The color selection part 134 selects the color used for the indicator 31 so that the amount of deterioration factors can be specified in the deterioration state determination executed by the deterioration determination part 137. The color selection part 134 then outputs the indicator data (printing data) so that the color pattern 33 containing the selected color can be printed by the printing device.

The identifier extraction part 135 extracts the identifier 32 from the image of the indicator 31 acquired by the data acquisition part 131. The identifier 32 extracted by the identifier extraction part 135 is used to identify the indicator 31 in the deterioration determination performed by the deterioration determination part 137.

The color component extraction part 136 extracts the color components of the colors contained in the color pattern 33 from the image of the indicator 31 acquired by the data acquisition part 131. The color components extracted by the color component extraction part 136 are used to determine the amount of deterioration factors in the deterioration determination performed by the deterioration determination part 137.

The deterioration determination part 137 uses the deterioration determination model 122 to determine the deterioration state of the hose 30 based on the color change database 121 and the color components extracted from the image of the indicator 31 by the color component extraction part 136. To explain in detail, the deterioration determination part 137 estimates (calculates) the amount of deterioration factors affected by the operating environment of the hose 30 by comparing the color components extracted from the image of the indicator 31 with the data in the color change database 121. The deterioration determination part 137 then inputs the estimated amount of the deterioration factors into the deterioration determination model 122, and the output deterioration state index of the hose 30 is taken as the determination result.

In this embodiment, the deterioration determination part 137 calculates the change in color components by comparing the color components extracted from the image of the indicator 31 with the initial state. The deterioration determination part 137 can obtain the initial state of the color components of the indicator 31 from the indicator database 123. The deterioration determination part 137 estimates the amount of deterioration factors by comparing the change in color components with the data in the color change database 121. In this embodiment, by comparing the initial state and determining the change in color components, even if there are individual differences in the creation of the indicators 31 (for example, variations in printing), the change in color can be accurately determined, so the deterioration state of the hose 30 can be determined with even higher precision.

The determination result output part 138 outputs the determination result of the deterioration state determination executed by the deterioration determination part 137. The determination result output by the determination result output part 138 is displayed on the display of the terminal device 50, etc. For example, users can decide to replace the hose 30 immediately or make a replacement plan based on the determination results.

The method for determining the deterioration state executed by the deterioration state determination device 10 is explained below, with reference to flowcharts and other diagrams. The method for determining the deterioration state includes the first, second and third processes. The first process is the process for generating the color change database 121 and the deterioration determination model 122, and is executed before the second and third processes. The second process is the process for creating the indicator 31 attached to the hose 30 (having it printed by the printing device 51), and is executed before the third process. The third process is the process for acquiring an image of the indicator 31 attached to the hose 30 and determining the deterioration state of the hose 30.

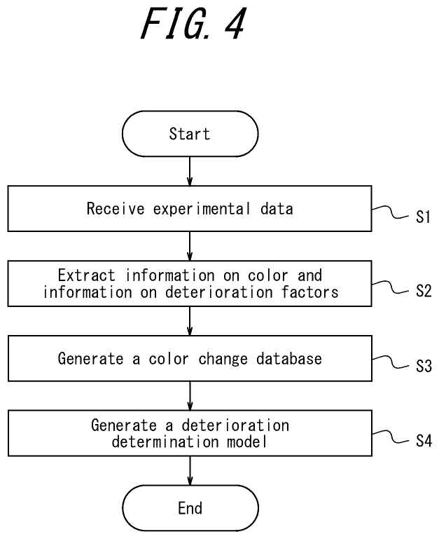

FIG. 4 is a flowchart providing an example of the first process included in the method for determining the deterioration state.

The data acquisition part 131 receives the experimental data (step S1). The experimental data was obtained by experimentally applying a deterioration factor to an experimental indicator created using a printing device 51 in the same way as the indicator 31, causing the color to fade. Similar to the color pattern of the indicator 31, the experimental indicator has a pattern with a plurality of colors arranged in it. The experimental data includes information on color and information on deterioration factors. The experimental data may include images of the experimental indicator that was captured, as well as information on the deterioration factors in the form of text. The information on the deterioration factors indicates the amount of deterioration factors given experimentally, and could be information such as: left in an environment with a temperature of 20° C. and an oxygen content of 20% for 20 hours.

The experimental data may be transmitted to the deterioration state determination device 10, for example, by the communication terminal used by the experimenter. The communication terminal may have the same configuration as the terminal device 50. For example, the image of the experimental indicator and the information on the deterioration factors may be associated by an application installed on the communication terminal and transmitted to the deterioration state determination device 1.

The color change database generation part 132 extracts the information on color and the information on deterioration factors from the experimental data (step S2).

The color change database generation part 132 generates data showing the relationship between the color change and the amount of deterioration factors, and generates the color change database 121 by relating these (step S3).

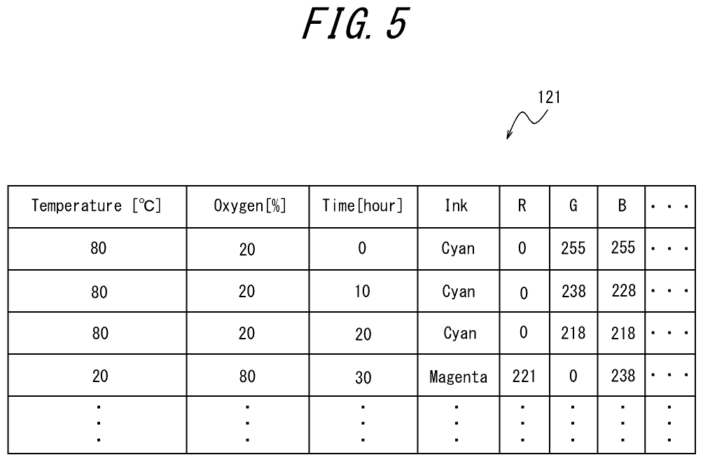

FIG. 5 illustrates an exemplary configuration of the color change database 121. In the example provided in FIG. 5, the color change database 121 is composed of a group of data that associates temperature (Temperature), oxygen (Oxygen), time it was left under the conditions (Time), the color of ink used (Ink), and color components (R, G, B) of the color used. The ink is indicated by colors such as cyan, magenta and yellow. In addition, the color components are indicated in shades of 0 to 255 for red (R), green (G) and blue (B) respectively.

In the example in FIG. 5, we can see from the first and second columns of the color change database 121 that cyan, which had a G value of 255 and a B value of 255 as color components, fades to a G value of 238 and a B value of 228 after being left in an environment with an oxygen content of 20% and a temperature of 80° C. for 10 hours. In this way, the color change database 121 shows the relationship between the color change and the amount of deterioration factors. Using this relationship, when there is a change in color (fading) in the color pattern 33 of the indicator 31, it becomes possible to estimate the amount of deterioration factors that caused the fading by searching for data in the color change database 121 that shows the same change on the color components.

The deterioration determination model generation part 133 generates the deterioration determination model 122 (step S4). As described above, the deterioration determination model 122 is a model that takes the amount of deterioration factors as input and outputs an index of the deterioration state of the hose 30. By generating the deterioration determination model 122 in addition to the color change database 121, it becomes possible to output an index of the deterioration state of the hose 30 from the fading of the color pattern 33 of the indicator 31, using the amount of the estimated deterioration factors as an intermediate parameter.

Here, the items in the color change database 121 are not limited to the example provided in FIG. 5. For example, the deterioration factors may include at least one of heat, oxygen, water, ultraviolet rays, and ozone. By including these deterioration factors that can be expected in outdoor environments, it becomes possible to improve the accuracy of the deterioration state determination of the hose 30 used outdoors. Here, the term “heat” is not limited to the temperature (e.g. air temperature) of the environment in which the hose 30 is used, but also includes the temperature of the internal fluid passing through the fluid flow path of the hose 30. For example, when a high-temperature fluid flows inside the hose 30, it is possible to determine the deterioration state of the hose 30, including deterioration caused by the fluid as well as deterioration caused by the external air.

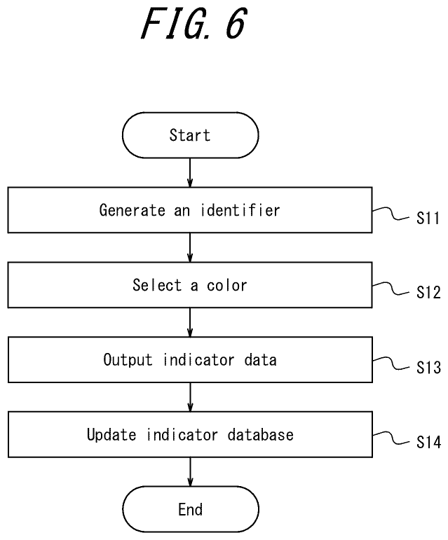

FIG. 6 is a flowchart providing an example of the second process included in the method for determining the deterioration state. The second process is executed after the first process. The second process is executed, for example, when it is time to replace the hose with a new one.

The color selection part 134 generates an identifier 32 to be printed on the indicator 31 (step S11). The identifier 32 is used in the indicator database 123 to associate the information of the indicator 31 and the color pattern 33. The identifier 32 allows each of the indicators 31 to be identified, making it possible to grasp the initial state and to manage them individually. The color selection part 134 may use a UUID (Universal Unique Identifier), for example.

The color selection part 134 selects a color to be used for the indicator 31 so that the amount of the deterioration factors can be identified (step S12).

As mentioned above, the degree of fading varies depending on the deterioration factors in the environment and the color of the ink. The color selection part 134 may first select a color that changes greatly due to the deterioration factors that are expected in the environment where the hose 30 is used (a color that is highly sensitive). For example, if a high temperature (e.g. 80° C.) is assumed to be a deterioration factor, the color selection part 134 may select a color (e.g. magenta) that fades significantly due to a high temperature. The color selection part 134 may also select a color for use as a contrast. The color selection part 134 may, for example, select a color that fades only under aerobic conditions due to a high temperatures (e.g., yellow) for use as a contrast. For example, in the deterioration state determination, if there is no fading of the yellow and the magenta has faded significantly, it is possible to more accurately identify that the deterioration factor is not oxygen but a high temperature. Here, the color selection part 134 refers to the color change database 121 when selecting a color. The color selection part 134 also specifies the color components of the selected color based on the data in the color change database 121, so that the amount of the deterioration factors can be accurately identified in the deterioration state determination. The color selection part 134 specifies the color components, for example, as magenta with R=255 and B=255. In addition, the color selection part 134 also determines the placement of each color in the color pattern 33. The position where each color is placed may be managed by coordinates.

In addition, the color selection part 134 selects a color that has color components that do not fade easily for the control correction described below and includes it in the indicator data.

In this embodiment, the color selection part 134 selects a plurality of colors that can identify the same deterioration factor and generates indicator data so that each of the plurality of colors that can identify the same deterioration factor is applied to different positions on the indicator 31. By constructing the color pattern in this way, even if part of the indicator becomes unidentifiable due to dirt or other factors after it has been attached to the hose, it is still possible to identify the deterioration factors from the remaining colors. As in the example in FIG. 3, the color selection part 134 may generate the indicator data so that a plurality of color patterns 33 are in different positions.

The color selection part 134 outputs the indicator data that includes the identifier 32 and the color pattern 33 data (step S13). The printing device 51 acquires the indicator data from the deterioration state determination device 10 as printing data via the network 40 and the server 60, and creates the indicator 31 by printing. The created indicator 31 is attached to the hose 30. In this embodiment, the created indicator 31 is captured by the terminal device 50, and the image is transmitted to the deterioration state determination device 10 as an indicator of the initial state of the indicator 31.

The color selection part 134 updates the indicator database 123 (step S14). In other words, the information in the indicator data output by the color selection part 134 is added to the indicator database 123. The information about the created indicator 31 is managed by the indicator database 123.

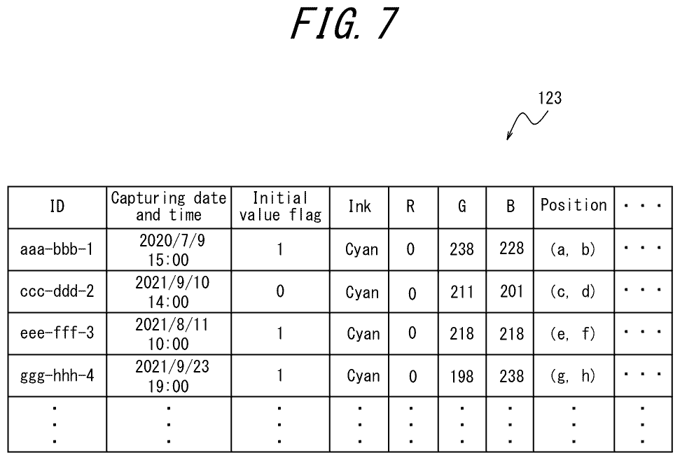

FIG. 7 illustrates an exemplary configuration of the indicator database 123. In the example in FIG. 7, the indicator database 123 is composed of a group of data that associates the identifier 32 (ID), the date and time of capturing, the initial value flag, ink (Ink), color components (R, G, B), and the position of the color. For the newly created indicator 31, the information about the identifier 32 and the color position is extracted from the indicator data, and the data is added with the initial value flag set to “1”. As described above, the image of the indicator 31 created by the terminal device 50 is transmitted to the deterioration state determination device 10. The date and time of capturing, the ink used, and the color components of this image are extracted and added to the data for the newly created indicator 31. Here, the extraction of ink and color components is performed by the color component extraction part 136, and the color selection part 134 may acquire the execution result of the color component extraction part 136. In the indicator database 123, the data with an initial value flag of “1” includes the initial color state of the indicator 31 with the identifier 32. Here, data with an initial value flag of “0” includes the color state after the indicator 31 with the identifier 32 is attached to the hose 30, and is added to the indicator database 123 by the third process.

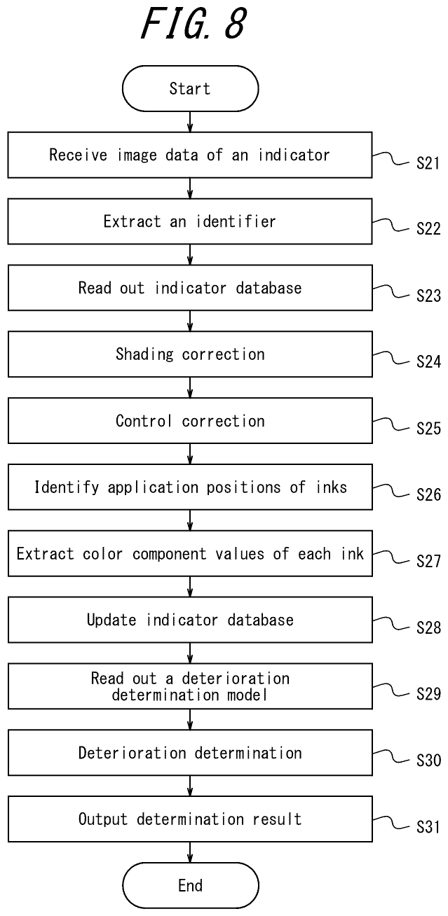

FIG. 8 is a flowchart providing an example of the third process included in a method for determining the deterioration state. The third process is executed after the second process. The third process is executed, for example, when maintenance is carried out on the hose 30. Therefore, the third process may be executed multiple times.

The data acquisition part 131 receives image data of the indicator 31 taken by the terminal device 50 during maintenance, for example (step S21). The identifier extraction part 135 extracts the identifier 32 from the image data acquired by the data acquisition part 131 (step S22).

The deterioration determination part 137 identifies the indicator 31 based on the identifier 32 extracted by the identifier extraction part 135. The deterioration determination part 137 reads out the indicator database 123 (step S23) and acquires data such as the initial state of the color of the specified indicator 31.

The color component extraction part 136 executes shading correction on the image data acquired by the data acquisition part 131 (step S24). The shading correction corrects for differences in light intensity within the color pattern 33 that occur due to the capturing environment.

The color component extraction part 136 executes control correction (step S25). The control correction is performed to accurately measure the change in the color of the indicator 31 from its initial state. The color component extraction part 136 extracts the color components (for example, the G component of cyan) that are not easily faded or changed in the color pattern 33 and adjusts their gradation to the initial state. By performing this process, the light level can be adjusted to match the image of the indicator 31 at the time of creation.

The color component extraction part 136 identifies the application positions of all the inks (colors) used in the color pattern 33, based on the data in the indicator database 123 (step S26). For example, the positions of cyan, magenta, yellow, and the mixing of at least some of these colors which are included in the color pattern 33, are specified.

The color component extraction part 136 extracts the color component values of each ink whose position has been identified (step S27). For example, as in the example in FIG. 3, when a plurality of color patterns 33 are included, the average value may be used as the color component values for each ink. In addition, if there is dirt on some parts, the color component values of each ink may be extracted using only the color pattern 33 of the area where there is no dirt. Although the color component values of the extracted inks themselves can be used to determine deterioration, in this embodiment, deterioration is determined by comparing the difference from the initial state. For this reason, the color component extraction part 136 uses the data in the indicator database 123 to calculate the change in the color component values of each ink from the initial state.

Here, the color component extraction part 136 updates the indicator database 123 in the same way as step S14 in the second process (step S28). The structure of the data added to the indicator database 123 is the same as in step S14 of the second process, except that the initial value flag is “0”.

The deterioration determination part 137 reads out the color change database 121. The deterioration determination part 137 also reads out the deterioration determination model 122 (step S29).

The deterioration determination part 137 uses the deterioration determination model 122 to determine the deterioration of the hose 30 based on the color change database 121 and the color components extracted from the image (step S30).

First, the deterioration determination part 137 extracts data corresponding to the change in color component values from the initial state from the color change database 121, to estimate the amount of deterioration factors that the hose 30 has received from the environment. For example, if cyan, which initially had a G component of 253 and a B component of 253, fades (changes) to a G component of 236 and a B component of 226, the deterioration determination part 137 calculates G=17 and B=27 as a color component change. The deterioration determination part 137 can extract data corresponding to such color component changes based on the color change database 121 and estimate that the amount of the deterioration factors is “left in an environment with a temperature of 20° C. and an oxygen content of 20% for 10 hours”. The deterioration determination part 137 may perform the estimation using a known method such as regression analysis using data that makes up the color change database 121.

In addition, the deterioration determination part 137 may calculate the color component changes for a plurality of color components that show different changes for a single deterioration factor, and may specify the amount of deterioration factors from the plurality of color component changes. For example, let's say that the color change database 121 contains data showing that the R value of magenta changes from 255 to 220 when it is left in an environment with a temperature of 80° C. and an oxygen content of 20% for 10 hours. For example, in addition to cyan in the above example, the deterioration determination part 137 can calculate and compare the change in the R value of magenta to improve the accuracy of the estimation of the amount of deterioration factors, and as a result, it can determine the deterioration state of the hose 30 with higher accuracy.

The deterioration determination part 137 calculates an index of the deterioration state of the hose 30 by inputting the amount of the deterioration factors into the deterioration determination model 122. The deterioration determination part 137 may calculate an index of the deterioration state of a plurality of hoses 30, including the service life.

The determination result output part 138 outputs the determination result from the deterioration determination part 137 (step S31).

Here, in the above embodiment, the indicator 31 is created when the hose 30 is replaced, and is immediately attached to the new hose 30. However, the indicator 31 may be attached to the hose 30 after some time has passed since it was created. Also, the indicator 31 may be attached during the manufacturing process of the hose 30. In other words, a hose 30 with an indicator 31 attached may be manufactured. In the distribution of the hoses like this, it is also possible to upload images of the initial state of the indicator 31 and images when determining the deterioration state to the deterioration state determination device 10 using a terminal device 50, for example. In this case, the terminal device 50 may be a device owned by the user who wants to know the deterioration state, the seller or manufacturer of the hose 30. The application installed on the terminal device 50 may perform everything from uploading the image of the indicator 31 to displaying the determination result from the deterioration state determination device 10.

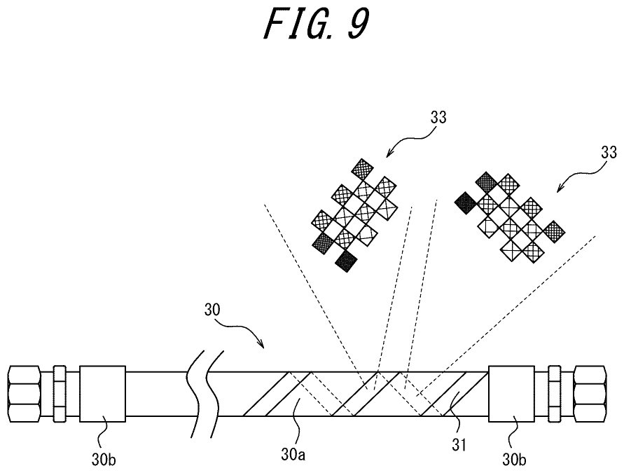

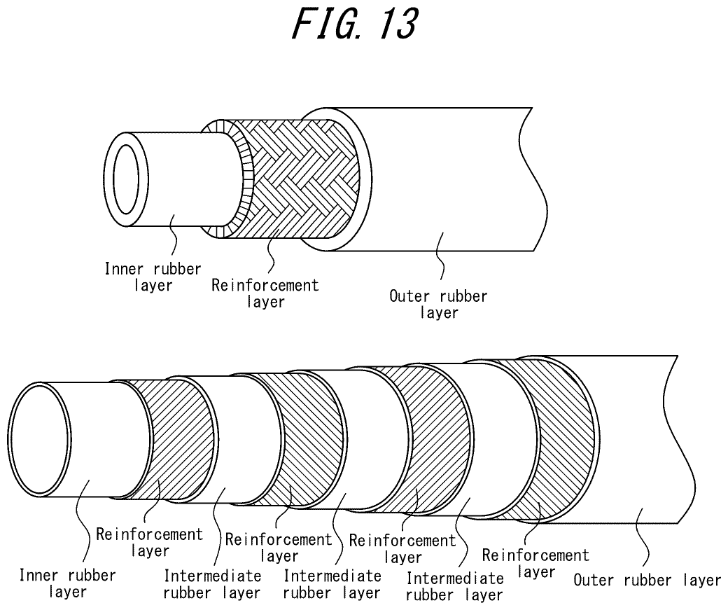

FIG. 9 illustrates an exemplary configuration of the hose 30 with the indicator 31 according to this embodiment. The hose 30 comprises a hose body 30a, a fitting 30b, and an indicator. The hose body 30a is made of rubber that forms a fluid flow path therein. The rubber may be composed of a plurality of layers. FIG. 13 is a perspective view illustrating an example of the laminated structure of the hose body 30a. The hose 30 is, for example, a hydraulic hose, and may have a structure like the one illustrated in the upper part in FIG. 13. For example, the hose 30 may have a structure in which an inner rubber layer (inner tube rubber) made of rubber that is filled with hydraulic fluid; a reinforcement layer that withstands the pressure of the hydraulic fluid; and an outer rubber layer (outer sheath rubber) that prevents damage to the reinforcement layer and the inner rubber layer, are laminated. Here, the reinforcement layer may be made of a brass-plated wire, for example, but is not limited to a specific material. In addition, the hose 30 may have a structure like the one illustrated in the lower part in FIG. 13 as another example. In this example, the hose 30 has a structure in which an inner rubber layer; a plurality of intermediate rubber layers and reinforcement layers laminated to the outer circumference of the inner rubber layer; and an outer rubber layer, are laminated.

The fitting 30b is connected to the end (one or both ends) of the hose 30a and is made of metal. The type of rubber and metal is not limited and can be selected according to the properties of the fluid that passes through the inside of the hose 30, for example. The indicator 31 has its color components extracted by the deterioration state determination device 10, which comprises the deterioration determination model 122 and the color change database 121 described above, in order to determine the deterioration state of the hose body 30a. The indicator 31 has a color pattern 33 in which a plurality of colors with different sensitivities to deterioration factors are applied to different positions. By using this color pattern 33, it is possible to determine the combined deterioration of the plurality of deterioration factors of the hose 30.

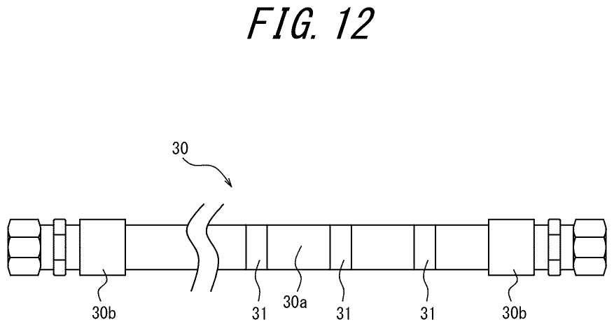

In the example in FIG. 9, there is one indicator 31, but there may be more than one (see FIG. 12). The indicator 31 has a plurality of color patterns 33, and is attached to the external surface of the hose body 30a so that the color patterns 33 can be seen from each of at least two different directions when the hose 30 is viewed from those directions. Here, at least two directions are perpendicular to the longitudinal direction of the hose 30. As mentioned above, the visibility of which part of the hose 30 is good or bad depends on how it is used. For example, if one side of the hose 30 is facing a wall, it will not be possible to determine the deterioration state if the indicator 31 is attached only to that side. The hose 30 with the indicator 31 according to this embodiment can be used to determine the deterioration state regardless of the usage state of the hose 30, because if the color pattern 33 cannot be seen from one direction, it can be seen from another direction.

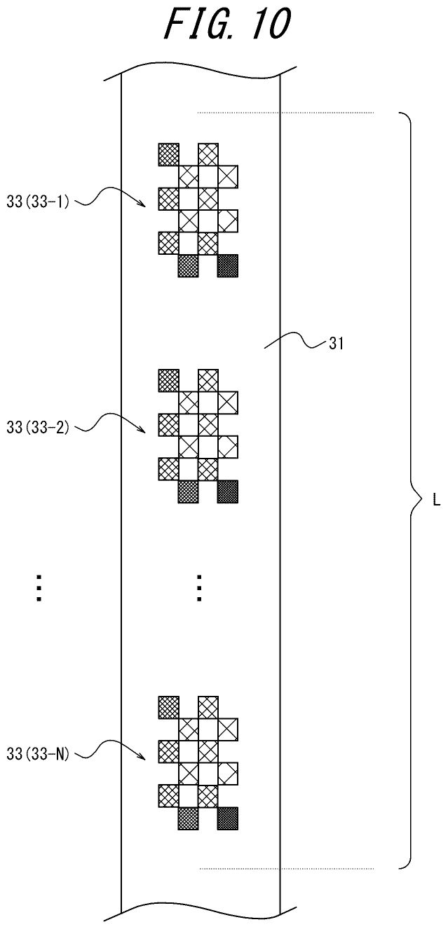

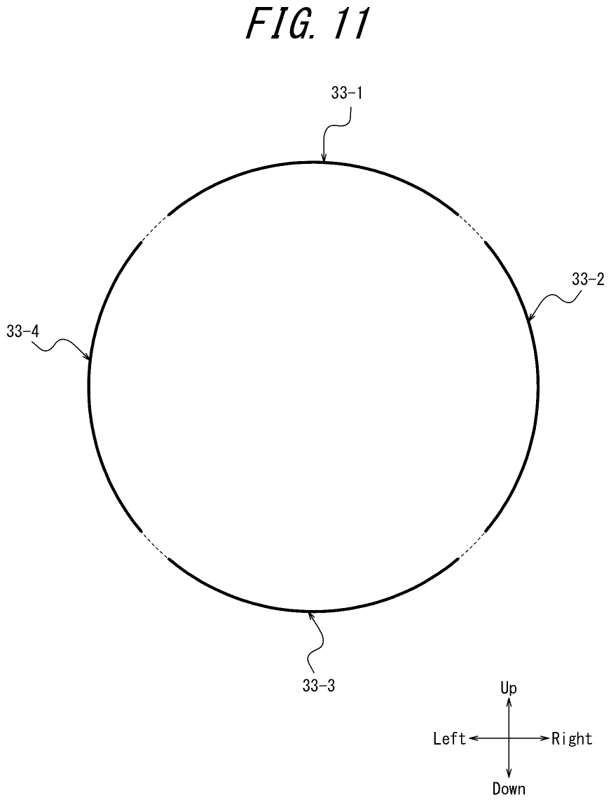

FIG. 10 explains the arrangement of the color patterns 33 of the indicator 31. In FIG. 10, the length of the indicator 31 that encircles the circumference of the hose body 30a is indicated as “L”. The indicator 31 is composed of N color patterns 33 arranged within a length “L”. Nis an integer greater than or equal to 2. In this case, when the hose 30 is viewed from N directions perpendicular to the longitudinal direction thereof, the color pattern 33 can be seen from each direction. FIG. 11 illustrates an exemplary cross-section of the hose body 30, and illustrating the case where N is 4. As illustrated in FIG. 11, when the user looks at the hose 30 from above, the color pattern 33-1 is visible. Also, when the user looks at the hose 30 from the right, the color pattern 33-2 is visible. In addition, when the user looks at the hose 30 from below, the color pattern 33-3 is visible. Further, when the user looks at the hose 30 from the left, the color pattern 33-4 is visible. For example, if the hose 30 is used so that the left side faces the building wall, the user can take a picture of one of the color patterns 33-1 to 33-3 from another direction using the terminal device 50. Here, although it is omitted in the illustration in FIG. 10, the indicator 31 is composed of N identifiers 32 arranged in the same way as the color patterns 33.

As in the example in FIG. 9, the indicator 31 may be attached in a spiral pattern to the external surface of the hose body 30a, for example. In this case, the hose 30 with the indicator 31 is manufactured by wrapping a single strip of the indicator 31 around part of the hose body 30a. This makes it easy to manufacture the hose 30 with the indicator 31 that allows the color pattern 33 to be seen from each of the plurality of directions. Also, as illustrated in FIG. 12, the indicators 31 may be attached circumferentially at a plurality of positions on the hose main body 30a. This circumferential direction is the direction along the circumference in the cross-section of the hose body 30a, as illustrated in FIG. 11. In addition, the plurality of positions are discrete positions that are spaced apart from each other with predetermined intervals in the longitudinal direction of the hose 30. The predetermined intervals can be regular intervals or irregular (variable) intervals. In this case, the color pattern 33 is visible at a plurality of positions and from each of the plurality of directions. Therefore, even if part of the hose becomes unidentifiable due to dirt or other factors, it is possible to determine the deterioration state from the remaining color patterns 33.

In addition, the color pattern 33 is configured to include a plurality of color components that show different changes in response to one of the deterioration factors. As described above, the accuracy of the estimation of the amount of deterioration factors has increased, and it is now possible to determine the deterioration state of the hose 30 with higher accuracy.

As described above, the hose 30 with the indicator 31 according to this embodiment allows the color pattern 33 to be seen from a plurality of directions, therefore, it is possible to determine the deterioration state regardless of the usage state of the hose 30.

The embodiments of the present disclosure have been described based on the various drawings and examples, but it should be noted that a person skilled in the art would be able to easily make various variations and modifications based on the present disclosure. Therefore, it should be noted that these variations and modifications are included within the scope of the present disclosure. For example, the functions contained in each component or each step, etc. can be rearranged so that they do not contradict logically, and it is possible to combine multiple components or steps, etc. into one or split them into multiple components or steps, etc. The embodiments according to the present disclosure can also be realized as a program executed by the processor provided to the device or as a storage medium storing the program. It is to be understood that these are also encompassed within the scope of the present disclosure.

The image of the indicator 31 used to extract the color components in the color component extraction step in the above embodiment is not limited to images captured under irradiation with visible light. For example, the image data of the indicator 31 may be an image captured under irradiation with invisible light such as UV (ultraviolet) light. In an image captured using invisible light, the color change (sensitivity) to certain deterioration factors may be greater than when the image is captured using visible light. Therefore, in cases where the effects of specific deterioration factors are to be investigated in detail, an image captured under irradiation with invisible light may be used.

1. A hose with an indicator, comprising:
a hose body made of rubber that forms a fluid flow path therein;
a fitting made of metal connected to an end of the hose body; and
an indicator in which color components are extracted by a deterioration state determination device provided with a deterioration determination model and a color change database in order to determine deterioration state of the hose body, wherein
the indicator has a plurality of color patterns composed of colors that are sensitive to deterioration factors, and is attached to an external surface of the hose body so that the color patterns can be seen from each of at least two different directions when the hose is viewed from those directions.

2. The hose with an indicator according to claim 1, wherein the indicator is attached in a spiral pattern to the external surface of the hose body.

3. The hose with an indicator according to claim 1, wherein the indicator is attached in a circumferential direction at a plurality of positions on the hose body.

4. The hose with an indicator according to claim 1, wherein in the color patterns, a plurality of colors with different sensitivities to the deterioration factors are applied to different positions.

5. The hose with an indicator according to claim 1, wherein the color pattern is configured to include a plurality of color components that show different changes in response to one of the deterioration factors.

6. The hose with an indicator according to claim 1, wherein the deterioration factors include at least one of heat, oxygen, water, ultraviolet rays, and ozone.

7. The hose with an indicator according to claim 2, wherein in the color pattern, a plurality of colors with different sensitivities to the deterioration factors are applied to different positions.

8. The hose with an indicator according to claim 2, wherein the color pattern is configured to include a plurality of color components that show different changes in response to one of the deterioration factors.

9. The hose with an indicator according to claim 2, wherein the deterioration factors include at least one of heat, oxygen, water, ultraviolet rays, and ozone.

10. The hose with an indicator according to claim 3, wherein in the color pattern, a plurality of colors with different sensitivities to the deterioration factors are applied to different positions.

11. The hose with an indicator according to claim 3, wherein the color pattern is configured to include a plurality of color components that show different changes in response to one of the deterioration factors.

12. The hose with an indicator according to claim 3, wherein the deterioration factors include at least one of heat, oxygen, water, ultraviolet rays, and ozone.

13. The hose with an indicator according to claim 4, wherein the color pattern is configured to include a plurality of color components that show different changes in response to one of the deterioration factors.

14. The hose with an indicator according to claim 4, wherein the deterioration factors include at least one of heat, oxygen, water, ultraviolet rays, and ozone.

15. The hose with an indicator according to claim 5, wherein the deterioration factors include at least one of heat, oxygen, water, ultraviolet rays, and ozone.

16. The hose with an indicator according to claim 7, wherein the color pattern is configured to include a plurality of color components that show different changes in response to one of the deterioration factors.

17. The hose with an indicator according to claim 7, wherein the deterioration factors include at least one of heat, oxygen, water, ultraviolet rays, and ozone.

18. The hose with an indicator according to claim 8, wherein the deterioration factors include at least one of heat, oxygen, water, ultraviolet rays, and ozone.

19. The hose with an indicator according to claim 10, wherein the color pattern is configured to include a plurality of color components that show different changes in response to one of the deterioration factors.

20. The hose with an indicator according to claim 10, wherein the deterioration factors include at least one of heat, oxygen, water, ultraviolet rays, and ozone.
